(19) United States
(12) Patent Application Publication
(10) Pub. No.: US 2026/0243370 A1
(43) Pub. Date: Aug. 20, 2026

(54) Bracket Device

(71) Applicant: Christopher Lawson, Chesapeake, VA (US)

(72) Inventor: Christopher Lawson, Chesapeake, VA (US)

(21) Appl. No.: 19/058,920

(22) Filed: Feb. 20, 2025

(51) Int. Cl. F16L 3/12; A62C 35/68

(52) U.S. Cl. CPC F16L 3/1211; A62C 35/68

(57) ABSTRACT

A bracket device for securing a sprinkler system pipe within a wall or ceiling includes a bracket with a base and a neck extending upwardly from the base. A sleeve coupled to the neck is hollow to define a channel positioned above the base. A pipe extends through the channel. A sprinkler head is removably couplable to the pipe wherein the pipe is designed to direct a fluid to the sprinkler head. A support is coupled to the bracket. The pipe extends past the support wherein the bracket secures a position of the pipe relative to the support. A surface is positioned proximate to the support wherein the pipe extends past the support through the surface and wherein the bracket secures a position of the pipe within the surface to inhibit movement of the pipe within the surface when the sprinkler head is removed from the pipe.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to fire suppression systems and more particularly pertains to a new bracket for securing a pipe within a wall or ceiling during installation and replacement of a sprinkler head that is coupled to the pipe.

### (2) Description of Related Art Including Information Disclosed Under 37 CFR 1.97 and 1.98

The prior art relates to fire suppression systems. Fire suppression systems are required in commercial and residential buildings. In commercial buildings, those systems typically include a sprinkler system, generally comprising a plurality of pipes embedded behind the walls and above the ceilings. These pipes extend through the walls and ceilings in places where sprinkler heads are coupled to the pipes. To inhibit damage to the pipes, the pipes need to be firmly secured behind the walls and above the ceilings during installation and replacement of the sprinkler heads. If the pipes are not held firmly enough, the plastic material of the pipes can break. Therefore, fire technicians typically need to cut through the wall or ceiling to expose a portion of the pipe. One fire technician then holds the exposed portion of the pipe, for example with a wrench, while a second fire technician attaches the sprinkler head to the end of the pipe. Thus, there is a need for a device which can secure the position of the pipe within the wall or ceiling, eliminating the need to cut through the wall or ceiling to install, remove, or replace sprinkler heads.

### (h) BRIEF SUMMARY OF THE INVENTION

An embodiment of the disclosure meets the needs presented above by generally comprising a bracket that has a base and a neck that is coupled to and extends upwardly from the base. A sleeve is coupled to the neck distally to the base. The sleeve is hollow wherein the sleeve defines a channel that is positioned above the base. A pipe is coupled to the sleeve of the bracket wherein the pipe extends through the channel. The channel has a diameter that is complementary to an outer diameter of the pipe wherein the sleeve secures the pipe to the bracket. A sprinkler head is removably couplable to the pipe wherein the pipe is configured to direct a fluid to the sprinkler head. A bracket is coupled to a support. The pipe extends past the support wherein the bracket secures a position of the pipe relative to the support. A surface is positioned proximate to the support wherein the pipe extends past the support through the surface and wherein the bracket secures a position of the pipe within the surface to inhibit movement of the pipe within the surface when the sprinkler head is removed from the pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a bracket device according to an embodiment of the disclosure.

FIG. 2 is a side view of an embodiment of the disclosure.

FIG. 3 is an exploded view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is an isometric view of an embodiment of the disclosure.

FIG. 8 is an in-use view of an embodiment of the disclosure.

### (J) DETAILED DESCRIPTION OF THE INVENTION

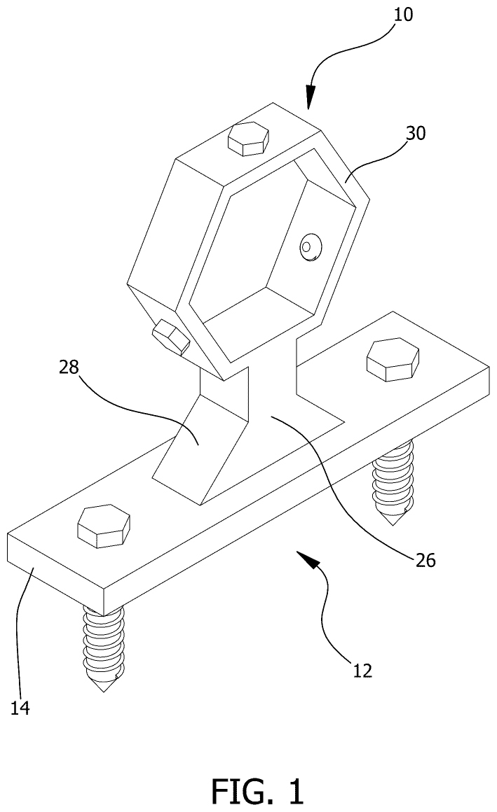

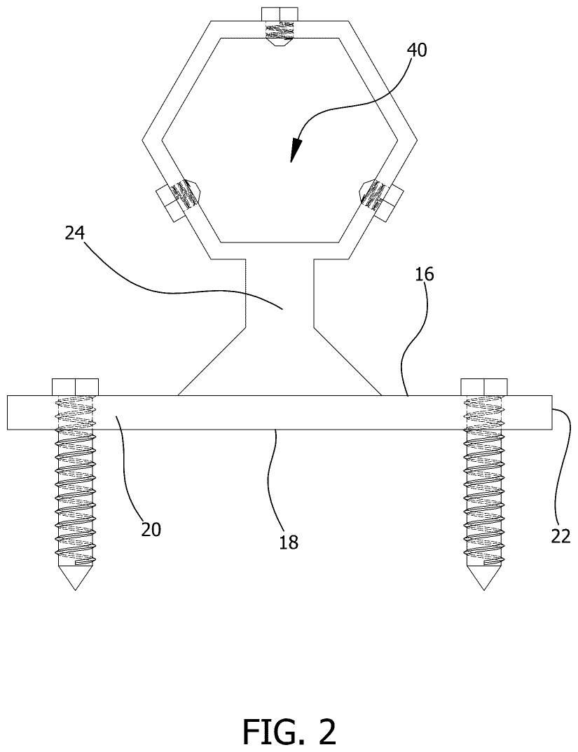

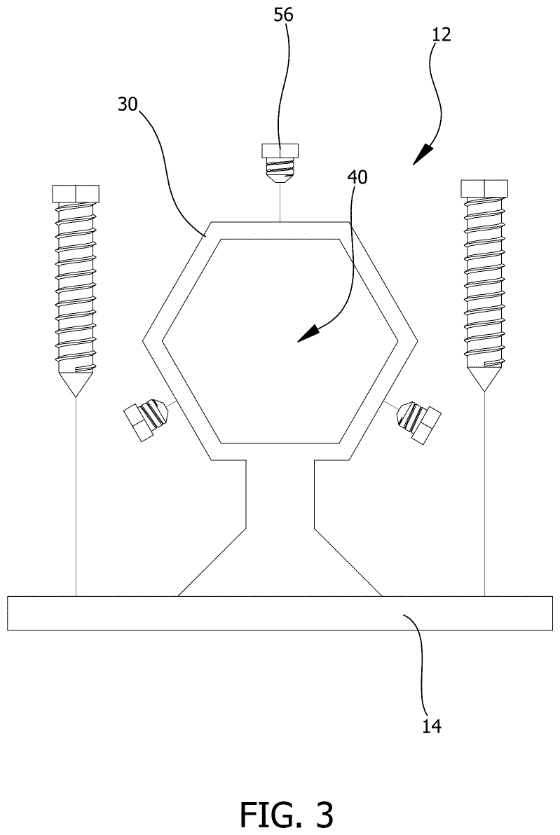

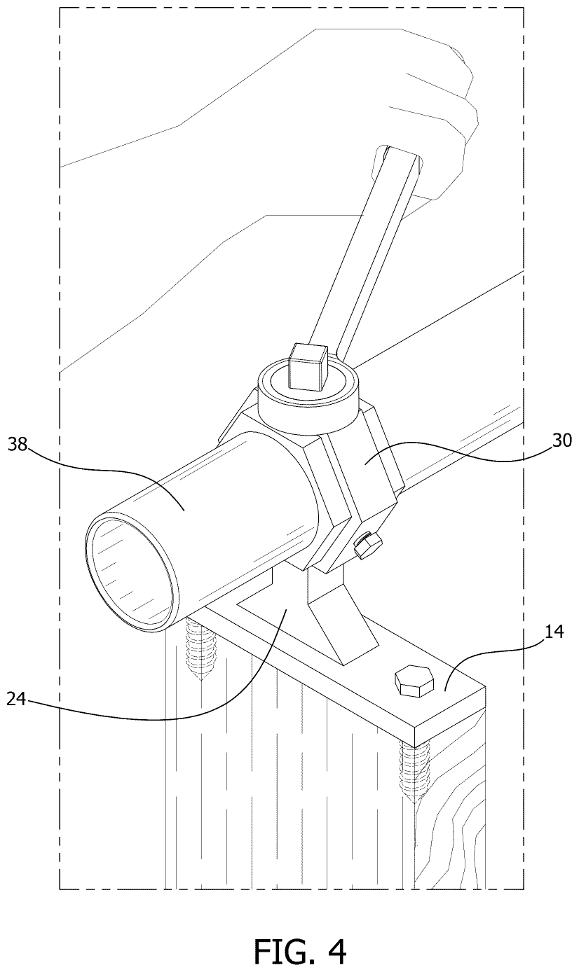

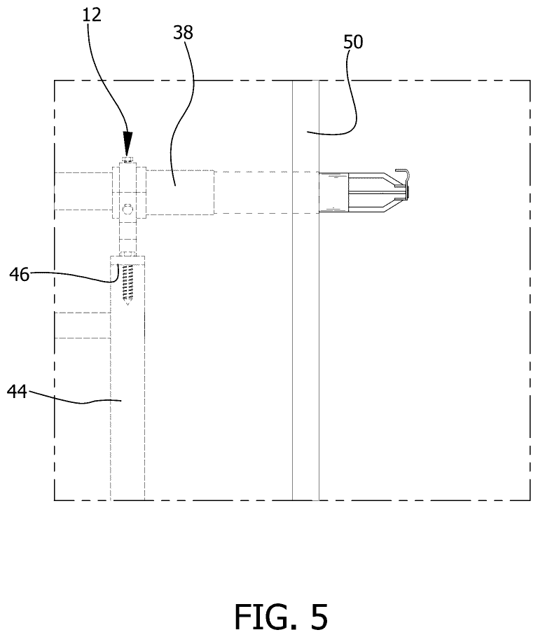

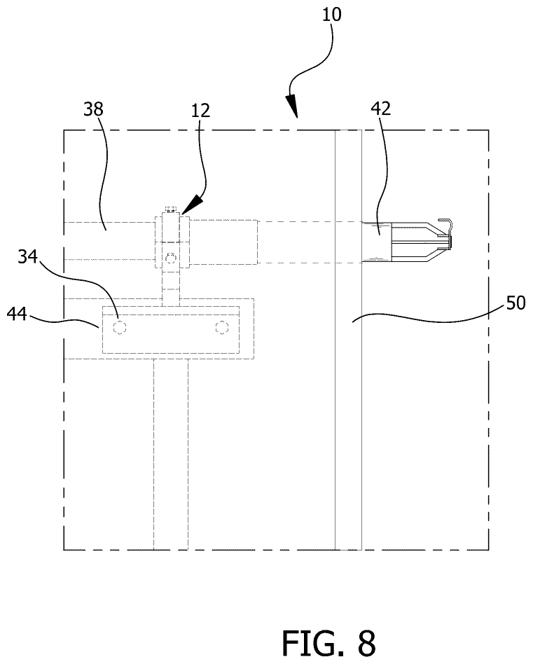

With reference now to the drawings, and in particular to FIGS. 1 through 8 thereof, a new bracket embodying the principles and concepts of an embodiment of the disclosure and generally designated by the reference numeral 10 will be described.

As best illustrated in FIGS. 1 through 8, the bracket device 10 generally comprises a bracket 12 which includes a base 14. Which generally includes a top surface 16 and a bottom surface 18. The bottom surface 18 of the base 14 is generally planar. The base 14 may further include a pair of elongated sides 20, which are generally parallel to each other. A pair of shortened sides 22 generally have a length that is less than a length of the pair of elongated sides 20. The pair of elongated sides 20 may extend between the pair of shortened sides 22. The pair of shortened sides 22 may be perpendicular to the pair of elongated sides 20.

A neck 24 is coupled to and extends from the base 14. More specifically, the neck 24 generally extends upwardly from the base 14. For example, the neck 24 may be perpendicular to the base 14. The neck 24 is also typically positioned on the top surface 16 of the base 14. The neck 24 may be centered on the top surface 16 of the base 14. The neck 24 may include a pair of opposing plates 26. Each opposing plate of the pair of opposing plates 26 may face toward a respective elongated side of the pair of elongated sides 20 of the base 14. A pair of opposing ends 28 extending between the pair of opposing plates 26 wherein each opposing end of the pair of opposing ends 28 faces toward a respective shortened side of the pair of shortened sides 22 of the base 14.

A sleeve 30 is coupled to the neck 24 distally to the base 14. The sleeve 30 is hollow wherein the sleeve 30 defines a channel 40 that is positioned above the base 14. The channel 40 may extend perpendicularly to the pair of elongated sides 20 of the base 14. As shown in the Figures, the channel 40 is hexagonal, although alternative shapes are contemplated. The sleeve 30 is also shown as hexagonal in the Figures, although alternative shapes for the sleeve 30 are also contemplated.

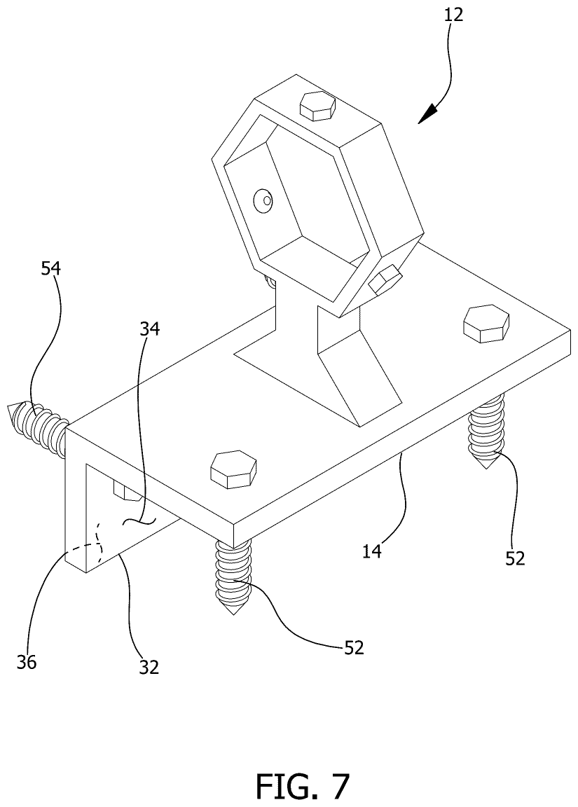

A bib 32 may be coupled to and extending from the base 14. For example, the bib 32 may extend downwardly from the bottom surface 18 of the base 14, as shown in FIG. 7. In such embodiments, the bib 32 generally has a height that is less than a height of the neck 24 wherein the channel 40 is positioned above the bib 32. The bib 32 is typically perpendicular to the base 14. Additionally, the bib 32 is generally positioned to extend from a respective elongated side of the pair of elongated sides 20 of the base 14. The bib 32 may have a primary side 34 facing toward the neck 24 and a secondary side 36 facing away from the neck 24. The secondary side 36 is generally planar.

A pipe 38 is coupled to the sleeve 30 of the bracket 12. More specifically, the pipe 38 extends through the channel 40. The channel 40 may have a diameter that is complementary to an outer diameter of the pipe 38 wherein the sleeve 30 secures the pipe 38 to the bracket 12. The pipe 38 may comprise a plastic material, which is commonly used in fire suppression systems.

A sprinkler head 42 is removably couplable to the pipe 38. More specifically, the sprinkler head 42 is typically threadably couplable to the pipe 38. The pipe 38 is generally configured to direct a fluid to the sprinkler head 42. The sprinkler head 42 is configured to release the fluid to inhibit growth of a fire. The sprinkler head 42 is removable from the pipe 38 to facilitate replacement of the sprinkler head 42.

A support 44 is coupled to the bracket 12. The pipe 38 extends past the support 44. The bracket 12 secures a position of the pipe 38 relative to the support 44. The support 44 includes a terminal end 46. The terminal end 46 may be planar wherein the bottom surface 18 of the base 14 is positioned flush against the terminal end 46 of the support 44. Moreover, the terminal end 46 may have a size that is equal to a size of the base 14 wherein the base 14 of the bracket 12 fully covers the terminal end 46 of the support 44. A pair of lateral sides 48 extend from the terminal end 46. The pair of lateral sides 48 may be perpendicular to the terminal end 46. Each lateral side of the pair of lateral sides 48 may be planar wherein the secondary side 36 of the bib 32 is positioned flush against an associated lateral side of the pair of lateral sides 48 of the support 44.

A surface 50 is positioned proximate to the support 44 wherein the pipe 38 extends past the support 44 through the surface 50. The sprinkler head 42 is positioned on an opposing side of the surface 50 from the support 44. Examples of the surface 50 include a wall and a ceiling through which the pipe 38 may extend as part of a sprinkler system for inhibiting growth of the fire, which may be burning either inside a building or next to a building. Common examples of the support 44 therefore include beams and columns which may be concealed behind the wall or the ceiling. The support 44 is often made of wood, although other materials are also contemplated. The surface 50 may be perpendicular to the pipe 38.

The bracket 12 secures a position of the pipe 38 within the surface 50 to inhibit movement of the pipe 38 within the surface 50 when the sprinkler head 42 is removed from the pipe 38. Traditional sprinkler head 42 installation and replacement methods typically require a user to hold the pipe 38 in place behind the surface 50 while an assistant removes the sprinkler head 42 from the pipe 38 or secures the sprinkler head 42 to the pipe 38. Such techniques therefore also require the user to cut through, or destroy, portions of the surface 50 to access the pipe 38. This further increases the labor and costs of sprinkler head 42 installation and replacement. The bracket 12 secures the position of the pipe 38 within the surface 50, eliminating the need for the user to hold the pipe 38 in place and thus eliminating the need for the user to cut through the surface 50 to access the pipe 38.

A pair of fasteners 52 may extend through the base 14 of the bracket 12 into the terminal end 46 of the support 44 to secure the base 14 to the terminal end 46 of support 44. The pair of fasteners 52 may be spaced from each other wherein the pair of fasteners 52 firmly secure an entirety of the base 14 to the support 44. For example, each fastener of the pair of fasteners 52 may be positioned adjacent to the respective shortened side of the pair of shortened sides 22 of the base 14 wherein the each fastener of the pair of fasteners 52 is positioned between the respective shortened side of the pair of shortened sides 22 of the base 14 and an associated opposing end of the pair of opposing ends 28 of the neck 24. The pair of fasteners 52 may be centered between the pair of elongated ends of the base 14.

A pair of couplers 54 may extend through the bib 32 of the bracket 12 into the associated lateral side of the pair of lateral sides 48 of the support 44 to secure the bib 32 to the associated lateral side of the pair of lateral sides 48 of the support 44. The pair of fasteners 52 are generally spaced from each other on the bib 32 wherein the pair of fasteners 52 firmly secure an entirety of the bib 32 to the associated lateral side of the pair of lateral sides 48 of the support 44.

A plurality of set screws 56 may extend through the sleeve 30 of the bracket 12 into the channel 40 to secure a position of the pipe 38 within the channel 40. The plurality of set screws 56 are spaced from each other around the sleeve 30 wherein the plurality of set screws 56 firmly secure an entirety of the pipe 38 within the channel 40.

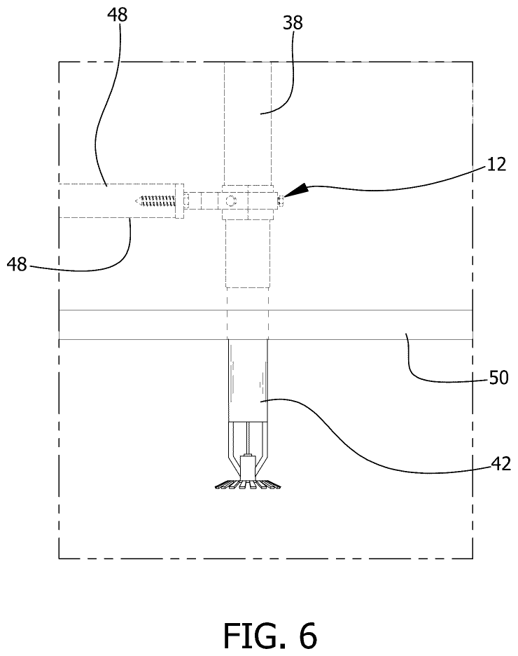

In use, the bracket 12 can be retrofitted into existing sprinkler systems or installed into new sprinkler systems. The bracket 12 extends from the support 44 to secure the position of the pipe 38 relative to the support 44, and to inhibit movement of the pipe 38 within the surface 50 when the sprinkler head 42 is removed from, and coupled to, the pipe 38. One or both of the base 14 and the bib 32 of the bracket 12 can be coupled to the support 44 to secure the position of the pipe 38 behind the surface 50. For example, when the sprinkler head 42 is an overhead sprinkler, such as the embodiment shown in FIG. 6, coupling the base 14 of the bracket 12 to the terminal end 46 of the support 44 may be preferred. Such embodiments may also be preferred when the terminal end 46 of the support 44 faces toward the surface 50. When the associated lateral side of the pair of lateral sides 48 of the support 44 faces toward the surface 50, coupling the bib 32 of the bracket 12 to the associated lateral side of the pair of lateral sides 48 of the support 44 may be preferred.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pipe stabilization system comprising:
a bracket including:
a base;
a neck being coupled to and extending upwardly from the base; and
a sleeve being coupled to the neck distally to the base, the sleeve being hollow wherein the sleeve defines a channel being positioned above the base;
a pipe being coupled to the sleeve of the bracket wherein the pipe extends through the channel, the channel having a diameter being complementary to an outer diameter of the pipe wherein the sleeve secures the pipe to the bracket;
a sprinkler head being removably couplable to the pipe wherein the pipe is configured to direct a fluid to the sprinkler head;
a support being coupled to the bracket, the pipe extending past the support wherein the bracket secures a position of the pipe relative to the support; and
a surface being positioned proximate to the support wherein the pipe extends past the support through the surface and wherein the bracket secures a position of the pipe within the surface to inhibit movement of the pipe within the surface when the sprinkler head is removed from the pipe.

2. The pipe stabilization system of claim 1, the base of the bracket further comprising:
a pair of elongated sides; and
a pair of shortened sides having a length being less than a length of the pair of elongated sides.

3. The pipe stabilization system of claim 2, the neck further comprising:
a pair of opposing plates, each opposing plate of the pair of opposing plates facing toward a respective elongated side of the pair of elongated sides of the base; and
a pair of opposing ends extending between the pair of opposing plates wherein each opposing end of the pair of opposing ends faces toward a respective shortened side of the pair of shortened sides of the base.

4. The pipe stabilization system of claim 3, wherein the channel extends perpendicularly to the pair of elongated sides of the base.

5. The pipe stabilization system of claim 3, further comprising a pair of fasteners extending through the base of the bracket into the support to secure the bracket to the support, the pair of fasteners being spaced from each other wherein the pair of fasteners firmly secure an entirety of the base to the support.

6. The pipe stabilization system of claim 5, wherein each fastener of the pair of fasteners is positioned adjacent to a respective shortened side of the pair of shortened sides of the base wherein the each fastener of the pair of fasteners is positioned between the respective shortened side of the pair of shortened sides of the base and an associated opposing end of the pair of opposing ends of the neck.

7. The pipe stabilization system of claim 6, wherein the pair of fasteners are centered between the pair of elongated ends of the base.

8. The pipe stabilization system of claim 2, the bracket further comprising a bib being coupled to and extending from the base, the bib being perpendicular to the base, the bib being positioned on a respective elongated side of the pair of elongated sides of the base.

9. The pipe stabilization system of claim 1, wherein the neck is perpendicular to the base.

10. The pipe stabilization system of claim 1, wherein the neck is centered on the base.

11. The pipe stabilization system of claim 1, the bracket further comprising a bib being coupled to and extending from the base.

12. The pipe stabilization system of claim 11, wherein the bib extends downwardly from the base.

13. The pipe stabilization system of claim 11, wherein the channel extends perpendicularly to the pair of shortened sides of the base.

14. The pipe stabilization system of claim 11, the support further comprising a pair of lateral sides wherein an associated lateral side of the pair of lateral sides is coupled to the bib of the bracket.

15. The pipe stabilization system of claim 1, the support further comprising a terminal end wherein the terminal end of the support is coupled to the base of the bracket.

16. The pipe stabilization system of claim 1, wherein the surface is perpendicular to the pipe.

17. The pipe stabilization system of claim 1, further comprising a plurality of set screws extending through the sleeve of the bracket into the channel to secure a position of the pipe within the channel.

18. The pipe stabilization system of claim 17, wherein the plurality of set screws are spaced from each other around the sleeve wherein the plurality of set screws firmly secure an entirety of the pipe within the channel.

19. A pipe stabilization system comprising:
a bracket including:
a base having a top surface and a bottom surface, the bottom surface of the base being planar, the base including:
a pair of elongated sides; and
a pair of shortened sides having a length being less than a length of the pair of elongated sides, the pair of elongated sides extending between the pair of shortened sides, the pair of shortened sides being perpendicular to the pair of elongated sides;
a neck being coupled to and extending upwardly from the base, the neck being perpendicular to the base, the neck being positioned on the top surface of the base, the neck being centered on the top surface of the base, the neck including:
a pair of opposing plates; and
a pair of opposing ends extending between the pair of opposing plates, each opposing end of the pair of opposing ends having a length being less than a length of the pair of opposing plates;
a sleeve being coupled to the neck distally to the base, the sleeve being hollow wherein the sleeve defines a channel being positioned above the base; and
a bib being coupled to and extending downwardly from the bottom surface of the base, the bib having a height being less than a length of the bib, the length of the bib being equal to the length of the base, the bib being perpendicular to the base, the bib being positioned on a respective elongated side of the pair of elongated sides of the base, the bib including:
a primary side facing toward the base; and
a secondary side facing away from the base, the secondary side being planar;
a pipe being coupled to the sleeve of the bracket wherein the pipe extends through the channel, the channel having a diameter being complementary to an outer diameter of the pipe wherein the sleeve secures the pipe to the bracket;
a sprinkler head being removably couplable to the pipe wherein the pipe is configured to direct a fluid to the sprinkler head and wherein the sprinkler head is configured to release the fluid to inhibit growth of a fire, the sprinkler head being removable from the pipe to facilitate replacement of the sprinkler head;
a support being coupled to the bracket, the pipe extending past the support wherein the bracket secures a position of the pipe relative to the support, the support including:
a terminal end being planar wherein the bottom surface of the base is positioned flush against the terminal end of the support, the terminal end having a size being equal to a size of the base wherein the base of the bracket fully covers the terminal end of the support; and
a pair of lateral sides extending from the terminal end, the pair of lateral sides being perpendicular to the terminal end, each lateral side of the pair of lateral sides being planar wherein the secondary side of the bib is positioned flush against an associated lateral side of the pair of lateral sides of the support;
a surface being positioned proximate to the support wherein the pipe extends past the support through the surface and wherein the sprinkler head is positioned on an opposing side of the surface from the support, the bracket securing a position of the pipe within the surface to inhibit movement of the pipe within the surface when the sprinkler head is removed from the pipe, the surface being perpendicular to the pipe;
a pair of fasteners extending through the base of the bracket into the terminal end of the support to secure the base to the terminal end of support, the pair of fasteners being spaced from each other wherein the pair of fasteners firmly secure an entirety of the base to the support, each fastener of the pair of fasteners being positioned adjacent to the respective shortened side of the pair of shortened sides of the base wherein the each fastener of the pair of fasteners is positioned between the respective shortened side of the pair of shortened sides of the base and an associated opposing end of the pair of opposing ends of the neck, the pair of fasteners being centered between the pair of elongated ends of the base;
a pair of couplers extending through the bib of the bracket into the associated lateral side of the pair of lateral sides of the support to secure the bib to the associated lateral side of the pair of lateral sides of the support, the pair of fasteners being spaced from each other on the bib wherein the pair of fasteners firmly secure an entirety of the bib to the associated lateral side of the pair of lateral sides of the support; and
a plurality of set screws extending through the sleeve of the bracket into the channel to secure a position of the pipe within the channel, the plurality of set screws being spaced from each other around the sleeve wherein the plurality of set screws firmly secure an entirety of the pipe within the channel.
